(19) United States
(12) Patent Application Publication
(10) Pub. No.: US 2014/0274305 A1
(43) Pub. Date: Sep. 18, 2014

(54) SMI FOR ELECTRONIC GAMING MACHINE SECURITY AND STABILITY

(71) Applicant: WMS GAMING, INC., Waukegan, IL (US)

(72) Inventors: Jorge L. Shimabukuro, Las Vegas, NV (US); Jun Wang, Henderson, NV (US); Gerardus A Weijers, Henderson, NV (US); Robert A. McPeak, Henderson, NV (US)

(73) Assignee: WMS GAMING, INC., Waukegan, IL (US)

(21) Appl. No.: 13/841,426

(22) Filed: Mar. 15, 2013

(51) Int. Cl. G07F 17/32

(52) U.S. Cl. CPC G07F 17/3241
USPC 463/24; 463/29

(57) ABSTRACT

A system and method for providing security services to an electronic gaming machine (EGM) utilizes system management interrupts (SMIs) triggered by security events to invoke execution by the EGM processor of one or more SMI handlers configured to provide a security service. Security events include the opening of an access panel on the EGM, an AC power loss to the EGM, a request for security attestation, a request for a secure encryption key, and other events requiring a secure operation to be carried out.

### TECHNICAL FIELD

The subject matter of the present disclosure relates generally to electronic gaming machine security and resilience to adverse events, and more particularly, to a system and method of implementing system management interrupt capabilities in an electronic gaming machine in such a way as to enhance machine security and resilience.

### BACKGROUND

Electronic gaming machines (EGMs) have provided a welcome reliability and ease of use to the world of gaming, enabling both the operator and the players to enjoy a more seamless and extended experience. However, with the advent of EGMs, certain problems not heretofore presented have become commonplace. For example, an EGM is typically based on a computing device having a processor for receiving and providing inputs and outputs respectively, as well as a computer-readable medium for storing process variables, instructions, and parameters; an adverse event that would not affect a mechanical gaming machine may well compromise the performance or security of an EGM. Similarly, an ill-intentioned person may seek to misdirect the operation of the processor in order to generate personal gain, e.g., by changing odds, causing a payout when none was earned and so on.

Thus, while EGMs present many opportunities for enhanced value and enjoyment to the operator and the players, EGMs also introduce a new risk of service disruption and tampering. Attempts have been made to further secure EGMs against such risks. For example, the cabinet in which an EGM is housed may be locked, and an interlock or theft detection device may be associated with the cabinet access door or panel.

However, most such countermeasures are susceptible to circumvention by a determined party having access to the EGM's memory and processor signals. Such a party may be able to trace processor operations and memory calls and then replay the appropriate codes and use the appropriate digital keys to interrupt or manipulate the operation of the EGM.

### SUMMARY

In an aspect of the disclosure, an EGM is provided having a processor for executing tasks within the EGM, the processor being configured to provide a system management mode (SMM) triggered via a system management instruction (SMI). A nonvolatile memory includes therein a basic input/output system (BIOS), the BIOS including one or more SMI handlers, the one or more SMI handlers being configured to provide a security service to the EGM. The BIOS is loaded upon start-up of the processor.

In another aspect of the disclosure, a computer readable medium is provided having thereon computer executable instructions for providing services on an EGM, the instructions comprising instructions for generating an SMI to a processor of the EGM when a security event is detected, causing the processor to enter SMM. Instructions embodying one or more SMI handlers corresponding to the SMI are also included on the computer-readable medium, the one or more SMI handlers being configured to provide a security service to the EGM.

In yet another aspect of the disclosure, a method is given for providing a security service to an EGM comprising retrieving instructions from a BIOS memory associated with the EGM (e.g., any memory media accessible to and authenticated by the BIOS) and installing one or more SMI handlers in keeping with the retrieved instructions, the one or more SMI handlers being configured to provide a security service with respect to the EGM. An SMI signal is received at a processor which then executes at least one of the one or more SMI handlers.

Other aspects of the disclosure will be appreciated upon reading the following detailed description in conjunction with the attached drawing figures.

### BRIEF DESCRIPTION OF THE DRAWINGS

So that the manner in which the above recited concepts and other concepts of the present disclosure may be understood in detail, a more particular description is provided by reference to the embodiments which are illustrated in the accompanying drawings. It is to be noted, however, that the appended drawings illustrate only example embodiments and are therefore not to be considered limiting; the concepts of the present disclosure also lend themselves to other equally effective embodiments. Moreover, the drawings are not necessarily to scale, since emphasis herein is generally placed upon illustrating the principles of certain embodiments.

Thus, for further understanding of these concepts and embodiments, reference may be made to the following detailed description, read in connection with the drawings in which:

FIG. 1 is a schematic architectural view of an electronic gaming machine within which embodiments of the disclosed principles may be implemented;

FIG. 2 is a system state diagram showing processor states and state transitions which may be employed within the described principles;

FIG. 3 is a flow chart illustrating a start-up process for an electronic gaming machine within which embodiments of the disclosed principles may be implemented;

FIG. 4 is a flow chart illustrating a process for security event response in accordance with embodiments of the disclosed principles; and

FIG. 5 is a flow chart illustrating a process for exchange of an encryption key in accordance with embodiments of the disclosed principles.

### DETAILED DESCRIPTION

Electronic gaming machines (EGMs) within which the disclosed principles may be implemented include stand-alone machines, back-to-back machines, side-by-side machines and other configurations that may be selected for practicality or convenience, whether portable or nonportable. As used herein, the term EGM will encompass all such variants, although the examples given are limited to single stand-alone machines for ease of explanation. Moreover, the game or type of game played on the EGM is not important. Possible games include, but are not limited to, video poker, video slots, video blackjack, video bingo, video keno, video roulette, video baseball, video lottery, Class 3 games, and others.

Broadly stated, the present disclosure pertains to the enhancement of security and stability in EGMs through the use of system management interrupt (SMI) calls in a particular manner. In overview, SMIs provide access to the processor in a manner that is independent of the operating system (OS) on the EGM. The use of an SMI call allows the processor to enter a System Management Mode (SMM), which is a processor mode providing high priority to the processor. When the processor enters the SMM mode via the SMI, all ongoing operating system tasks are suspended and are resumed only after the triggered SMI handler gets serviced. The operating system cannot disable or override the SMM mode and cannot track the SMI execution footprint. While default SMI handlers in the BIOS only have chipset knowledge (to monitor sensors etc.), the disclosure provides systems and methods related to new SMI handlers to monitor the OS and the EGM. In particular, the disclosure provides examples regarding the leveraging and customization of SMI triggers and handlers to enhance the security and reliability of the EGM.

Referring now to FIG. 1, a schematic illustration of an example EGM is shown. The example EGM 1 includes a body or cabinet 2 for enclosing the other components of the EGM 1. The cabinet 2 may include an opening to allow a user to view a display screen 3. In embodiments wherein sound is provided to the user, one or more speakers 4 may be used to project audio material via one or more corresponding openings in the cabinet 2.

A locked access panel may also be included to allow authorized personnel to access the interior of the cabinet 2, e.g., to provide software or hardware maintenance or update services. Within the cabinet 2, a chassis supports a number of components including a processor 5. The processor 5 may be referred to as a central processing unit (CPU), and is responsible for interpreting and executing (processing) commands and instructions. Thus, the processor 5 accepts one or more inputs, retrieves data and instructions, executes tasks, and provides one or more outputs.

In an embodiment, the processor 5 is a digital processor configured to read computer-executable instructions from, or originating from, a non-transitory computer-readable medium and executing those instructions. The non-transitory computer-readable medium may be any of an optical disc drive, hard disc drive, magnetic disc drive, flash drive, RAM, ROM, and so on.

The processor 5 is communicatively linked to memory 6, which may include volatile memory 7 as well as nonvolatile memory 8. Volatile memory 7 may comprise one or more RAM units or other volatile memory components. Nonvolatile memory 8 may comprise standard processor-accessible nonvolatile memory 9, e.g., an optical or magnetic hard disc, flash memory, etc., as well as more primitive nonvolatile memory for storing start-up instructions and basic machine data, e.g., a BIOS (basic input output system) memory 10. A trusted platform module 13 is also included in the EGM 1 to assist with encryption and decryption.

The BIOS memory 10 will be generally referred to simply as the BIOS 10. The BIOS 10 (or more properly the contents thereof) is the first software run by a computerized device such as the EGM 1 when first powered on. The purposes of the BIOS 10 is generally to initialize and test system hardware, and to load the operating system for the EGM 1. In keeping with its name, the BIOS 10 provides a mechanism for application programs such as games to interact with system input/output devices.

In an embodiment wherein the EGM 1 communicates over a network, e.g., to one or more other EGMs and/or to a central server or manager, one or more network communication modules 11 are provided within the EGM 1. The one or more communication modules 11 may be of a wired or wireless architecture, and may be configured to operate in the open or in an encrypted manner. Wireless protocols may be short range, e.g., in keeping with IEEE 802.11 or the like, and/or may be longer range, e.g., in keeping with cellular protocols. In addition, communications may be direct or may be indirect, e.g., via a peer network or one or more servers.

In an embodiment, the processor 5 is an IA-64 or IA-32 processor configured to support a system management mode (SMM) triggered via a system management interrupt (SMI). However, while this processor group will be used to provide examples of the disclosed concepts, it should be appreciated that the interrupt mode and the associated functions and structures, while not always referred to by the same names, may be common to other processor groups as well.

An overview of the SMM and the use of SMIs is given for the benefit of the casual reader. SMM provides an alternative operating mode usable to manage system resources for purposes such as power management. The SMM was introduced into the IA-32 architecture with the INTEL386 SL processor and is now supported by numerous other processors.

SMM is supported for use by system firmware, as opposed to application software or general purpose system software. An SMI may be sent to the processor via an SMI pin on the processor or may be sent via an SMI message sent on the APIC (advanced programmable interrupt controller) bus. SMM operates in an isolated fashion, transparently to the operating system or applications, and all other interrupts normally handled by the operating system are disabled when in SMM. Additional SMIs are also disabled when in SMM, although the first SMI received while in SMM may be latched for execution once the original SMI completes. When the SMM is invoked via an appropriate SMI, the processor 5 saves its current state and then switches to a separate operating environment contained in system management RAM (SMRAM). The processor then executes code specifically configured for execution when entering SMM based on an SMI. These specifically configured code segments are referred to as SMI handlers.

When a particular SMI handler has completed its task, it sends a resume operation instruction (RSM) to the processor 5, and the processor 5 then reloads its prior state or context and switches back to a normal operating mode, e.g., a protected or real mode. At this point, any operation or task that was underway when the SMI arrived will be restarted at the point of the context save.

With respect to the use of the SMM and SMI handlers in EGMs, the inventors have found that the SMM may be leveraged to provide enhanced security to EGMs. In overview, in an example embodiment providing an anti-tampering function, the cabinet 2 includes a door open sensor 12. The sensor 12 is configured and connected such that opening of a cabinet door generates an SMI via the sensor 12, the SMI then being sent to the processor 5. The SMI causes the processor 5 to suspend and save context for any ongoing operations and to enter the SMM.

Within the SMM, the appropriate SMI handler executes a security check operation. In a further embodiment, the security check operation includes the validation of the operating system (OS) kernel memory data. If the validation succeeds, that is, if the SMI handler finds that the OS kernel memory has not been tampered with, then the SMI handler calls RSM and the processor 5 resumes its previous state. If instead the validation does not succeed, indicating that the OS kernel memory has been modified without authorization, the SMI handler does not call RSM. In this situation, the processor 5 remains in the SMM awaiting forensic analysis of the suspect tampering with the OS kernel memory.

The simplified state diagram 15 of FIG. 2 illustrates operational states that the processor 5 (FIG. 1) may reside in and state transitions that the processor 5 may make during normal operation as well as upon receiving an SMI or an RSM instruction. The processor 5 is placed in a real-address mode 16 following a power-up or reset. The real-address mode 16 provides the programming environment of the processor 5, with certain extensions such as the ability to switch to other modes.

A PE flag in a control register CR0 then controls whether the processor 5 continues to operate in the real address mode 16 or instead transitions to the protected mode 17. The protected mode 17 is the native operating mode of the processor 5. It provides a set of architectural features as well as backward compatibility to the existing software base. If the PE flag is set (PE=1), then the processor 5 transitions to the protected mode 17, and otherwise (PE=0), the processor 5, remains in the real address mode.

Similarly, a VM flag in an EFLAGS register determines whether the processor 5 continues in the protected mode 17 or instead transitions to a virtual-8086 mode 18. The virtual-8086 mode 18 is a quasi-operating mode that allows the processor 5 to execute software in a protected, multitasking environment. If the VM flag is set (VM=1), then the processor 5 transitions from the protected mode 17 to the virtual-8086 mode 18. Otherwise (i.e., if VM=0), the processor 5 does not transition to the virtual-8086 mode 18 but rather remains in the protected mode 17.

An additional IA-32e mode 19 may be accessible from the protected mode 17 as well. In IA-32e mode 19, the processor supports two sub-modes, including a compatibility mode 21 and a 64-bit mode 22. The 64-bit mode 22 provides 64-bit linear addressing and support for physical address space larger than 64 GBytes, while the compatibility mode 21 allows most legacy protected-mode applications to run unchanged. The processor 5 transitions to the IA-32e mode 19 based on a flag such as an LMA flag. In particular, if the LMA flag is set (LMA=1), then the processor 5 will enter the IA-32e mode 19 by enabling paging and setting an LME bit.

From any operating mode, e.g., from any of the real address mode 16, protected mode 17, virtual-8086 mode 18 and IA-32e mode 19, the processor 5 will switch to the system management mode (SMM) 20 upon receipt of an SMI. Similarly, while in the SMM 20, and upon receipt of an RSM instruction, the processor 5 will switch from the SMM 20 back to the mode from which the processor 5 entered the SMM 20.

The flow charts of FIG. 3 and FIG. 4 illustrate example embodiments of EGM initialization and the SMI-driven security process in greater detail. Both processes are executed in the context of an enclosed EGM cabinet 2 having an access door monitored by a sensor 12 as discussed above. It will be appreciated, however, that the SMI that causes the processor 5 to enter the SMM may be generated alternatively or additionally via another security monitoring mechanism such as a line sniffer, tilt sensor, and so on.

At stage 31 of the initialization process 30, the EGM 1 is powered on or restarted. As the EGM 1 begins operation, the processor 5 boots a specialized BIOS at stage 32, e.g., BIOS 10 (FIG. 1) containing one or more security-related SMI handlers in addition to ordinary BIOS software. The SMI handlers may additionally or alternatively reside in other media accessible to the BIOS. At stage 33, the processor 5 loads the operating system pursuant to instructions from the BIOS 10. Once the operating system is running in protected mode, the processor 5 loads the game or games to be played on the EGM 1 at stage 34. At this point in the process 30, the game of interest is operational on the EGM 1.

When and if a security condition arises, the EGM 1 reacts, in an embodiment, in the manner shown in the process 35 of FIG. 4. At stage 36 of the process 35, with the operating system of the EGM 1 running in protected mode, a security event is detected, generating an SMI to the processor 5. It will be appreciated that the security event may result from the triggering of a hardware or software sensor or detector as discussed above; in the illustrated example, the security event is the detection via the sensor 12 that the cabinet access door has been opened.

The processor 5 receives the SMI at stage 37, and subsequently at stage 38 starts a protected mode-to-SMM transition. At stage 39, all running tasks in the OS are suspended and the processor 5 saves the OS context in SMRAM. At stage 40, the processor 5 enters SMM and begins execution of any SMI handlers associated with the SMI. In this example the SMI handlers operate at stage 41 to validate the OS kernel memory data.

If the validation succeeds, the process 35 continues to stage 42 wherein the SMI handler calls the RSM instruction. At stage 43, in accordance with the RSM instruction, the processor 5 begins a SMM-to-protected mode transition, restoring the saved OS context. At stage 44, the OS resumes operation of the game at the state in which it existed at the time that the SMI was received. The process 35 then returns to stage 36 to continue normal operation and await any further SMIs.

If the validation does not succeed at stage 41, indicating that the OS kernel memory has been modified without authorization, the process 35 continues to stage 45 wherein the SMI handler does not call RSM. In this situation, the processor 5 remains in the SMM awaiting forensic analysis of the suspect tampering with the OS kernel memory.

In another example, custom SMI handlers are configured and employed to protect system codes and encryption keys. Such a process 50 is illustrated in FIG. 5. At the outset of the process 50, the processor 5 boots the BIOS 10 at stage 51, installing SMI handlers and booting the OS. In an embodiment, an encryption key is stored in the TPM 13 during the execution of stage 51. The OS loads the game to played at stage 52, and the processor 5 is then left running the OS and the game in protected mode.

At stage 53 of the process 50, an OS component requires access to the encryption key stored in the TPM 13, and thus generates an SMI. The processor 5, in receipt of the SMI, begins the protected mode-to-SMM transition at stage 54, suspending all running tasks in the OS and saving the OS context in the SMRAM. Subsequently at stage 55, the processor 5 enters the SMM mode and executes the installed SMI handler, which calls BIOS TPM services in order to retrieve the requested encryption key and store the retrieved key in an agreed memory location in RAM (volatile memory 7).

At stage 56, the SMI handler calls the RSM instruction and the processor 5 begins the transition from SMM back to the protected mode operation, restores the OS context, and resumes execution of suspended tasks. The requesting OS component then retrieves the encryption key passed by the SMI handler at stage 57 and cleans up the copy of the encryption key from the agreed location in memory. Through this series of operations, the OS is thus able to obtain a copy of the encryption key without leaving a trail of operations that may be tracked by a debugger or other traditional mechanism.

Although the above examples discuss the use of custom SMI handlers for providing kernel memory data verification and for protecting the transmission of an encryption key, it will be appreciated that the disclosed principles are more widely applicable. For example, the nonvolatile memory 8 of the EGM 1 may include nonvolatile random access memory (NVRAM). Such memory is useful for storing state over normal on-off power cycles, e.g., to store running totals or values, locally maintained statistics, and so on. However, in the event of a power interruption, an NVRAM power-loss protection routine must typically be scheduled in order to prevent further writing to the NVRAM. The timing of the routine is traditionally significant.

However, through the use of SMIs and SMI handlers, the timing of the NVRAM power-loss protection routine can be decoupled from real time allowing the NVRAM power-loss protection routine to be executed when convenient. In particular, in this embodiment, all AC fail interrupts are routed to an SMI. The SMI handler thus invoked then locks down the NVRAM, preventing further writing. The SMI handler is executed prior to any OS tasks, and as such is able to prevent any further NVRAM writing when AC power fails.

As another example, the SMIs and SMI handlers described herein may be used to provide safe networked remote security attestation, which may be defined and constrained by law, e.g., to verify the correctness of data. In particular, in an embodiment, the SMI handler is network enabled to communicate with a remote attesting server. This provides a more secure and robust attestation than can be otherwise provided, in that the runtime stack is very thin, making it less vulnerable to a runtime attack, and it is only dependent on the BIOS media, which can be independently verified.

As a further example, the described techniques also find application with respect to preserving the EGM state for later forensic analysis. In this embodiment, in addition to the use of an SMI handler to execute a security check as described above, an SMI handler can be used, if the validation does not succeed, to preserve the machine state. In particular, when the OS is or appears to be frozen and static, the processor 5 will ordinarily shut down the EGM 1. However, an SMI handler can be used as a “tickler” to ping the OS watchdog, allowing the machine to remain on while awaiting forensic analysis.

While the present disclosure has shown and described details of exemplary embodiments, it will be understood by one skilled in the art that various changes in detail may be effected therein without departing from the spirit and scope of the disclosure as defined by claims supported by the written description and drawings. Further, where these exemplary embodiments (and other related derivations) are described with reference to a certain number of elements it will be understood that other exemplary embodiments may be practiced utilizing either less than or more than the certain number of elements.

What is claimed is:

1. An electronic gaming machine (EGM) comprising:
a processor for executing tasks within the EGM, the processor being configured to provide a system management mode (SMM) triggered via a system management interrupt (SMI);
a nonvolatile memory having therein a basic input/output system (BIOS), the BIOS including one or more SMI handlers, the one or more SMI handlers being configured to provide a security service to the EGM; and
a volatile memory wherein the BIOS is loaded upon start-up of the processor and wherein an operating system (OS) kernel memory data is stored.

2. The EGM in accordance with claim 1, wherein at least one of the one or more SMI handlers is configured to attempt to verify the validity of information associated with the EGM.

3. The EGM in accordance with claim 2, wherein the at least one of the one or more SMI handlers is configured to issue a resume instruction (RSM) when the validity of the information is verified.

4. The EGM in accordance with claim 3, wherein the at least one of the one or more SMI handlers is configured to maintain the processor in the SMM when the validity of the OS kernel memory data is not verified.

5. The EGM in accordance with claim 4, wherein the OS includes an OS watchdog component, and wherein maintaining the processor in the SMM includes periodically sending a tickler to the OS watchdog component.

6. The EGM in accordance with claim 1, wherein at least one of the one or more SMI handlers is configured to obtain cryptographic key material on behalf of the OS by retrieving the cryptographic key material from a secure location, storing the retrieved cryptographic key material in a memory location accessible to the OS, and issuing an RSM instruction.

7. The EGM in accordance with claim 1, wherein the nonvolatile memory of The EGM further includes a nonvolatile RAM (NVRAM), and wherein at least one of the one or more SMI handlers is configured to prevent the OS from writing to the NVRAM in the event of an AC power failure.

8. The EGM in accordance with claim 1, wherein the EGM is further configured to communicate with a remote attesting server, and wherein at least one of the one or more SMI handlers is configured to communicate with the remote attesting server to provide a remote security attestation.

9. A non-transitory computer readable medium associated with an EGM and having thereon computer executable instructions, the instructions comprising:
instructions for generating an SMI to a processor of the EGM when a security event is detected, causing the processor to enter SMM; and
instructions embodying one or more SMI handlers corresponding to the SMI, the one or more SMI handlers being configured to provide a security service to the EGM.

10. The non-transitory computer readable medium in accordance with claim 9, wherein at least one of the one or more SMI handlers is configured to attempt to verify the validity of information associated with the EGM.

11. The non-transitory computer readable medium in accordance with claim 10, wherein the at least one of the one or more SMI handlers is configured to issue an RSM instruction when the validity of the information is verified.

12. The non-transitory computer readable medium in accordance with claim 11, wherein the at least one of the one or more SMI handlers is configured to maintain the processor in the SMM when the validity of the OS kernel memory data is not verified.

13. The non-transitory computer readable medium in accordance with claim 12, wherein maintaining the processor in the SMM includes periodically sending a tickler to an OS watchdog component.

14. The non-transitory computer readable medium in accordance with claim 9, wherein at least one of the one or more SMI handlers is configured to obtain cryptographic key material by retrieving the cryptographic key material from a secure location, storing the retrieved cryptographic key material in a memory location accessible to an OS, and issuing an RSM instruction.

15. The non-transitory computer readable medium in accordance with claim 9, wherein at least one of the one or more SMI handlers is configured to prevent writing to a NVRAM in the event of an AC power failure.

16. The non-transitory computer readable medium in accordance with claim 9, wherein at least one of the one or more SMI handlers is configured to communicate with a remote attesting server to provide a remote security attestation.

17. A method of providing a security service to an electronic gaming machine EGM comprising:
retrieving instructions from a BIOS memory by a processor associated with the EGM;
installing by the processor one or more SMI handlers in keeping with the retrieved instructions, wherein the one or more SMI handlers are configured to provide a security service with respect to the EGM; and
receiving at the processor an SMI signal at a processor and executing at the processor at least one of the one or more SMI handlers.

18. The method according to claim 17, wherein the at least one of the one or more SMI handlers is configured to attempt to verify the validity of OS kernel memory data, to issue an RSM instruction when the validity of the OS kernel memory data is verified, and to maintain the processor in the SMM when the validity of the OS kernel memory data is not verified.

19. The method according to claim 17, wherein at least one of the one or more SMI handlers is configured to obtain cryptographic key material by retrieving the cryptographic key material from a secure location, storing the retrieved cryptographic key material in a memory location accessible to an OS, and issuing an RSM instruction.

20. The method according to claim 17, wherein at least one of the one or more SMI handlers is configured to prevent writing to a NVRAM of the EGM in the event of an AC power failure.
